(19) United States
(12) Patent Application Publication
(10) Pub. No.: US 2012/0162343 A1
(43) Pub. Date: Jun. 28, 2012

(54) IMAGE FORMING APPARATUS

(75) Inventor: Wataru FUJISHIRO, Anjo-shi (JP)

(73) Assignee: BROTHER KOGYO KABUSHIKI KAISHA, Aichi-ken (JP)

(21) Appl. No.: 13/293,706

(22) Filed: Nov. 10, 2011

(30) Foreign Application Priority Data
Dec. 27, 2010 (JP) 2010-289461

(51) Int. Cl. B41J 2/47

(52) U.S. Cl. 347/225

(57) ABSTRACT

A light receiving sensor receives laser light scanned by a light deflector and generates a detection signal. A pseudo-signal generating section generates a pseudo signal having a cycle that has the same length as a generation cycle of the detection signal. A lighting control section controls lighting start timing at which a light emitting element starts lighting based either on the detection signal or on the pseudo signal. A condensation determining section determines whether possibility that condensation occurs at the light receiving sensor is high based on a predetermined criterion. A malfunction determining section determines that the light receiving sensor has malfunction if the light receiving sensor fails to generate the detection signal within a predetermined period. A lighting control section controls the lighting start timing based on the pseudo signal, if it is determined that the possibility is high and that the light receiving sensor has malfunction.

### CROSS REFERENCE TO RELATED APPLICATIONS

This application claims priority from Japanese Patent Application No. 2010-289461 filed Dec. 27, 2010. The entire content of the priority application is incorporated herein by reference.

### TECHNICAL FIELD

The invention relates to an image forming apparatus.

### BACKGROUND

Conventionally, in an image forming apparatus such as a laser printer, a BD (beam detect) sensor detects scanned laser light, and generates a BD signal with a scanning cycle of the laser light. The lighting start timing of laser light modulated based on image data is controlled by using the BD signal.

### SUMMARY

If condensation occurs inside a main casing of such a laser printer, the BD sensor fails to generate a normal BD signal, resulting that printing cannot be performed until condensation is removed.

In view of the foregoing, it is an object of the invention to provide an image forming apparatus that is capable of forming images appropriately, even when condensation occurs.

In order to attain the above and other objects, the invention provides an image forming apparatus. The image forming apparatus includes a main casing, a photosensitive member, a light emitting element, a light deflector, a light receiving sensor, a pseudo-signal generating section, a lighting control section, a condensation determining section, and a malfunction determining section. The light emitting element is configured to emit laser light. The light deflector is configured to deflect the laser light and to scan the photosensitive member with the laser light in a main scanning direction to form an electrostatic latent image. The light receiving sensor is configured to receive the laser light scanned by the light deflector and to generate a detection signal. The pseudo-signal generating section is configured to generate a pseudo signal having a cycle that has the same length as a generation cycle of the detection signal. The lighting control section is configured to control lighting start timing at which the light emitting element starts lighting based either on the detection signal or on the pseudo signal. The condensation determining section is configured to determine whether possibility that condensation occurs at the light receiving sensor is high based on a predetermined criterion. The malfunction determining section is configured to determine that the light receiving sensor has malfunction if the light receiving sensor fails to generate the detection signal within a predetermined period. The lighting control section is configured to control the lighting start timing based on the pseudo signal, if the condensation determining section determines that the possibility is high and if the malfunction determining section determines that the light receiving sensor has malfunction.

According to another aspect, the invention also provides an image forming apparatus. The image forming apparatus includes a main casing, a photosensitive member, a light emitting element configured to emit laser light, a light deflector, a light receiving sensor, a pseudo-signal generating section, alighting control section, a condensation determining section, and a print controlling section. The light emitting element is configured to emit laser light. The light deflector is configured to deflect the laser light emitted from the light emitting element and to scan the photosensitive member with the laser light in a predetermined direction. The light receiving sensor is configured to receive the laser light deflected by the light deflector and to generate a detection signal. The pseudo-signal generating section is configured to generate a pseudo signal. The lighting control section is configured to control lighting start timing of the light emitting element based either on the detection signal or on the pseudo signal. The condensation determining section is configured to determine whether possibility that condensation occurs at the light receiving sensor is high based on a predetermined criterion. The print controlling section is configured to perform printing in a first print mode if the condensation determining section determines that the possibility is not high, and to perform printing in a second print mode if the condensation determining section determines that the possibility is high. In the second print mode, the lighting control section is configured to control the lighting start timing based on the detection signal if the light receiving sensor generates the detection signal within a predetermined period after forced lighting of the light emitting element, and to control the lighting start timing based on the pseudo signal if the light receiving sensor fails to generate the detection signal within the predetermined period.

According to still another aspect, the invention also provides an image forming apparatus. The image forming apparatus includes a main casing; a photosensitive member; a light emitting element configured to emit laser light; a light deflector configured to deflect the laser light and to scan the photosensitive member with the laser light in a main scanning direction to form an electrostatic latent image; a light receiving sensor configured to receive the laser light scanned by the light deflector and to generate a detection signal; means for generating a pseudo signal having a cycle that has the same length as a generation cycle of the detection signal; means for controlling lighting start timing at which the light emitting element starts lighting based either on the detection signal or on the pseudo signal; means for determining whether possibility that condensation occurs at the light receiving sensor is high based on a predetermined criterion; and means for determining that the light receiving sensor has malfunction if the light receiving sensor fails to generate the detection signal within a predetermined period. The lighting start timing is controlled based on the pseudo signal, if it is determined that the possibility is high and that the light receiving sensor has malfunction.

### BRIEF DESCRIPTION OF THE DRAWINGS

Embodiments in accordance with the invention will be described in detail with reference to the following figures wherein:

FIG. 1 is a vertical cross-sectional view showing a laser printer embodying an image forming apparatus according to a first embodiment of the invention;

FIG. 2 is a schematic diagram showing the configuration of a scanner unit in the laser printer shown in FIG. 1;

FIG. 3 is a block diagram showing the electrical configuration of the laser printer shown in FIG. 1;

FIG. 4 is a flowchart showing a print job process of the laser printer according to the first embodiment;

FIG. 5 is a flowchart showing an exposure control in a normal print mode;

FIG. 6 is a flowchart showing an exposure control in a condensation print mode;

FIG. 7 is a flowchart showing a pseudo-signal generating process;

FIG. 8A is a waveform chart showing a relationship between a BD signal and a pseudo signal;

FIG. 8B is a waveform chart showing a relationship between generation timing of the BD signal and lighting timing of a laser diode (LD), in the normal print mode;

FIG. 8C is a waveform chart showing a relationship between generation timing of the BD and pseudo signals and lighting timing of the LD, in the condensation print mode;

FIG. 9 is a flowchart showing a print job process in a laser printer according to a second embodiment; and

FIG. 10 is a flowchart showing a print job process in a laser printer according to a third embodiment.

### DETAILED DESCRIPTION

### First Embodiment

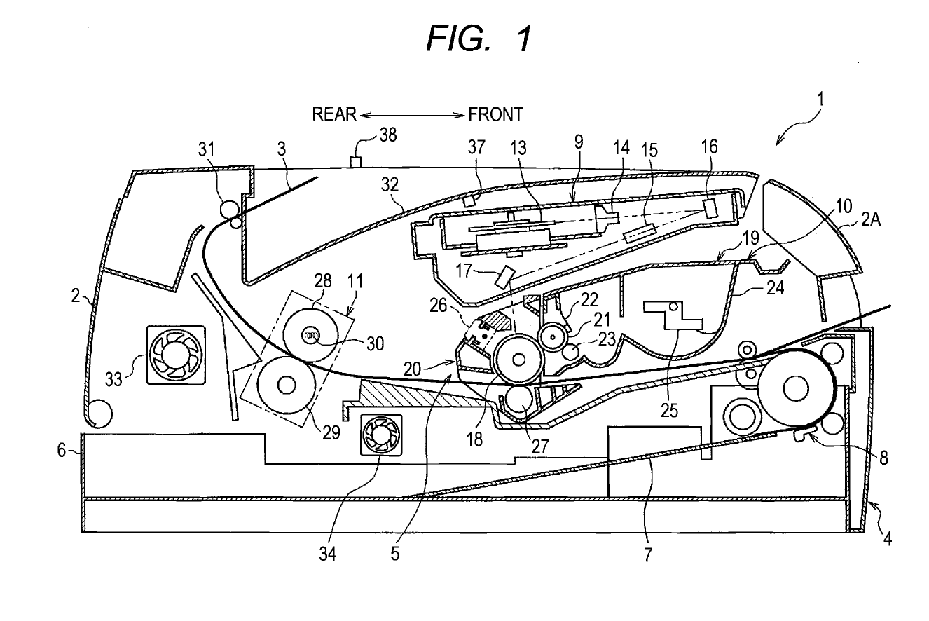

An image forming apparatus according to a first embodiment will be described with reference to FIGS. 1 through 8C. The image forming apparatus of the embodiment is applied to a laser printer 1. In the following description, the expressions “front”, “rear”, “upper”, “lower”, “right”, and “left” are used to define the various parts when the laser printer 1 is disposed in an orientation in which it is intended to be used. That is, in FIG. 1, the right side in the drawing sheet is referred to as the “front” side, the left side in the drawing sheet is referred to as the “rear” side, the far side in the direction perpendicular to the drawing sheet is referred to as the “right” side, and the near side in the direction perpendicular to the drawing sheet is referred to as the “left” side. Further, the upper and lower sides in the drawing sheet are referred to as the “upper” and “lower” sides, respectively.

<Overall Configuration of Laser Printer 1>

As shown in FIG. 1, the laser printer 1 includes a main casing 2 serving as an apparatus main body and, within the main casing 2, a feeder section 4 for feeding paper 3, an image forming section 5 for forming an image on the paper 3, and the like.

<Configuration of Feeder Section 4>

The feeder section 4 has a known structure, and mainly includes a paper feeding tray 6, a paper pressing plate 7, and a paper conveying mechanism 8. In the feeder section 4, the paper 3 in the paper feeding tray 6 is lifted by the paper pressing plate 7, and is conveyed to the image forming section 5 by the paper conveying mechanism 8.

<Configuration of Image Forming Section 5>

The image forming section 5 includes a scanner unit 9, a process cartridge 10, a fixing section 11, and the like. The scanner unit 9 and the process cartridge 10 form a developer image on the paper 3. The fixing section 11 thermally fixes, on the paper 3, the developer image transferred onto the paper 3 by the process cartridge 10.

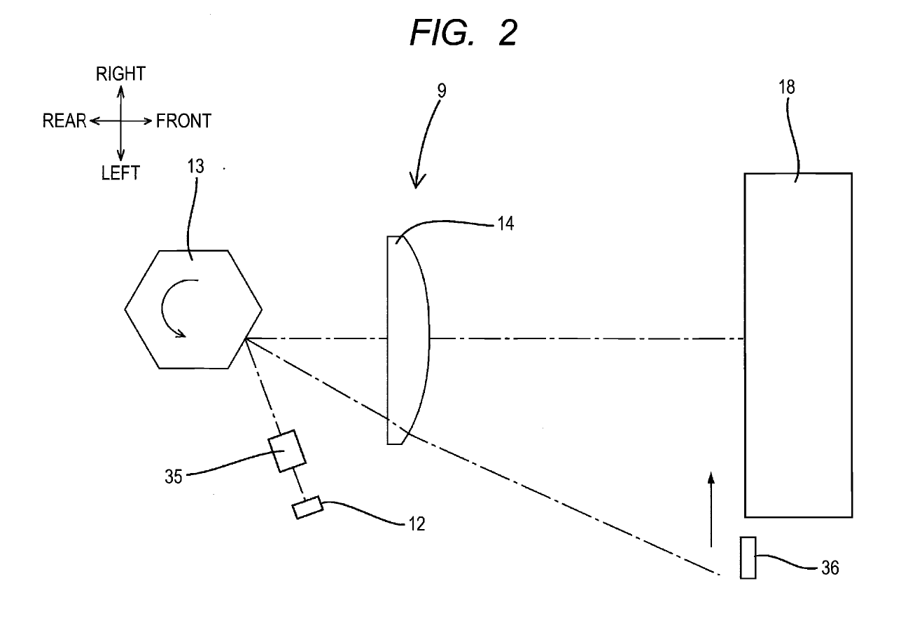

The scanner unit 9 includes a laser diode (LD) 12 (see FIG. 2) that emits laser light and serves as a light emitting element, a polygon mirror 13 rotatably driven to scan laser light in a predetermined range, an fθ lens 14, a toric lens 15, reflection mirrors 16 and 17, and the like. Laser light emitted from the LD 12 travels along a path indicated by the double-dot chain lines in FIG. 1 to be irradiated onto a surface of a photosensitive member 18. The configuration of the scanner unit 9 will be described in greater detail later. The polygon mirror 13 is an example of a light deflector.

The process cartridge 10 can be mounted to or dismounted from the main casing 2 in a state where a front cover 2A of the main casing 2 is opened. The process cartridge 10 mainly includes a developing cartridge 19 and a drum unit 20.

The developing cartridge 19, together with the drum unit 20, is detachably mounted to the main casing 2. Or, the developing cartridge 19 is detachably mounted to the drum unit 20 fixed to the main casing 2. The developing cartridge 19 mainly includes a developing roller 21, a layer-thickness regulating blade 22, a supplying roller 23, and a toner hopper 24.

In the developing cartridge 19, developer in the toner hopper 24 is agitated by an agitator 25, and is subsequently supplied to the developing roller 21 by the supplying roller 23, at which time developer is positively tribocharged between the supplying roller 23 and the developing roller 21. As the developing roller 21 rotates, developer supplied onto the developing roller 21 enters between the layer-thickness regulating blade 22 and the developing roller 21 to be further tribocharged, and is borne on the developing roller 21 as a thin layer of a constant thickness.

The drum unit 20 mainly includes the well-known photosensitive member 18, a Scorotron charger 26, and a transfer roller 27. Within the drum unit 20, the surface of the photosensitive member 18 is uniformly positively charged by the Scorotron charger 26, and is subsequently exposed by being irradiated with laser light modulated in accordance with image data from the scanner unit 9. This lowers an electric potential of an exposed portion, so that an electrostatic latent image based on image data is formed.

Then, rotation of the developing roller 21 causes developer borne on the developing roller 21 to be supplied to the electrostatic latent image formed on the surface of the photosensitive member 18, and a developer image is formed on the surface of the photosensitive member 18. Subsequently, the paper 3 is conveyed between the photosensitive member 18 and the transfer roller 27, so that the developer image borne on the surface of the photosensitive member 18 is transferred onto the paper 3.

The fixing section 11 has a known structure, and includes a heat roller 28 and a pressure roller 29. A halogen heater 30 is provided within the heat roller 28 for heating the same. In the fixing section 11, the developer image transferred on the paper 3 is thermally fixed to the paper 3 while the paper 3 passes between the heat roller 28 and the pressure roller 29. The paper 3 that has passed through the fixing section 11 is sent onto a paper discharge tray 32 by paper discharging rollers 31. The main casing 2 is provided with a first fan 33 and a second fan 34. The first fan 33 discharges, to outside the main casing 2, heat and water vapor that emanate from the fixing section 11 and from the paper 3. The second fan 34 introduces air outside the main casing 2 into the main casing 2.

As shown in FIG. 1, an internal temperature sensor 37 for detecting internal temperature (internal air temperature) Ta inside the apparatus is provided within the main casing 2. Also, a temperature-humidity sensor 38 for external temperature (external air temperature) Tb and external humidity Hb outside the apparatus is provided on an outer surface of the main casing 2.

<Configuration of Scanner Unit 9>

In FIG. 2, the right side in the drawing sheet is referred to as the “front” side, the left side in the drawing sheet is referred to as the “rear” side, the upper side in the drawing sheet is referred to as the “right” side, and the lower side in the drawing sheet is referred to as the “left” side. The scanner unit 9 includes a lens section 35, a BD (beam detect) sensor 36, and the like, in addition to the LD 12, the polygon mirror 13, the fθ lens 14, the toric lens 15 (see FIG. 1), the reflection mirrors 16 and 17 (see FIG. 1). The lens section 35 includes a collimator lens, a cylindrical lens, and the like. The BD sensor 36 is an example of a light receiving sensor.

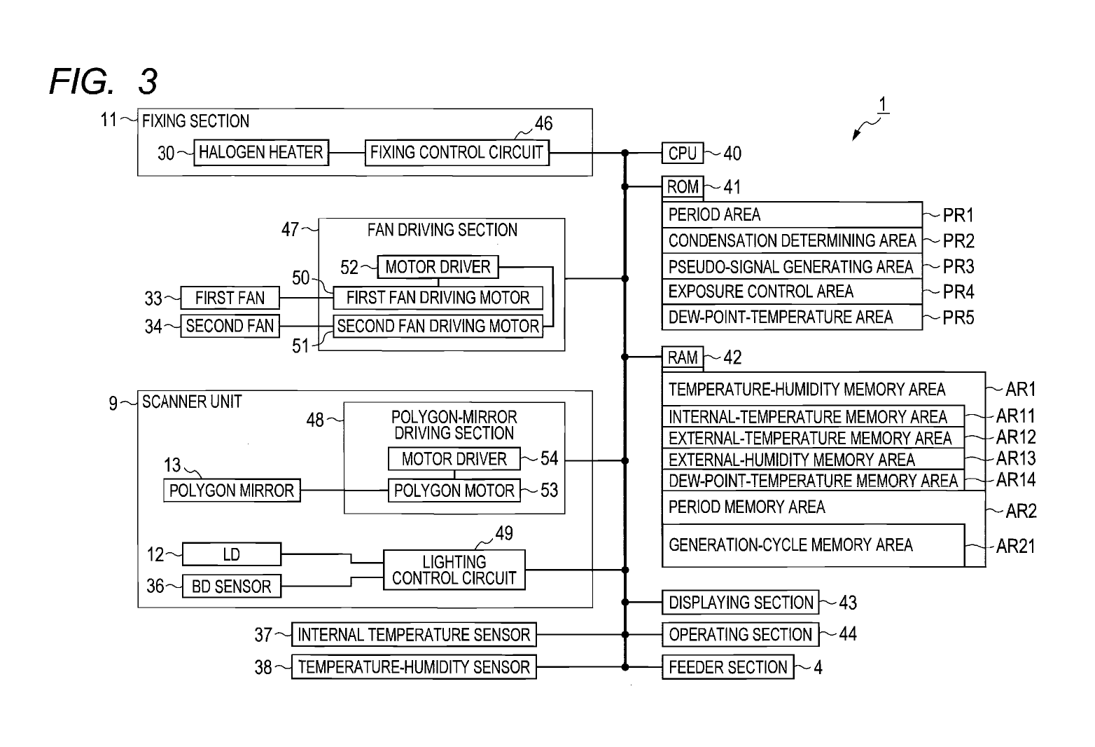

The LD 12 turns on and off in accordance with signals outputted from a lighting control circuit 49 (see FIG. 3). Laser light emitted from the LD 12 is irradiated onto the polygon mirror 13 via the lens section 35. The polygon mirror 13 is rotated at high speed by a polygon motor 53. Laser light irradiated onto the polygon mirror 13 is deflected by the polygon mirror 13, and is irradiated onto the photosensitive member 18 via the fθ lens 14, the reflection mirror 16, the toric lens 15, and the reflection mirror 17. Note that the reflection mirror 16, the toric lens 15, and the reflection mirror 17 are omitted in FIG. 2, for simplicity. Laser light deflected by one mirror surface of the polygon mirror 13 is scanned along one line of the photosensitive member 18. As shown in FIG. 2, the polygon mirror 13 rotates in the counterclockwise direction, as viewed from the upper side. Laser light is scanned from the left side to the right side. Thus, laser light is irradiated on the BD sensor 36 and the photosensitive member 18 in this order.

The polygon mirror 13 includes six mirror surfaces so as to deflect laser light cyclically. In the present embodiment, one cycle is defined as a period in which laser light is deflected by one mirror surface of the polygon mirror 13. Thus, in the present embodiment, the polygon mirror 13 rotates once in six cycles.

The BD sensor 36 is disposed at a position through which laser light deflected by the polygon mirror 13 passes before the laser light scans the photosensitive member 18. Based on an output from the BD sensor 36, lighting start timing of the LD 12 is determined for starting scanning the photosensitive member 18 with laser light for each line at printing. Upon receiving laser light emitted from the LD 12, the BD sensor 36 generates a BD (beam detect) signal and outputs the signal to the lighting control circuit 49.

<Electrical Configuration of Laser Printer 1>

Next, the electrical configuration of the laser printer 1 will be described. As shown in FIG. 3, the laser printer 1 includes a CPU 40, a ROM 41, a RAM 42, a displaying section 43, an operating section 44, the feeder section 4, the scanner unit 9, the fixing section 11, a fan driving section 47, the internal temperature sensor 37, the temperature-humidity sensor 38, and the like.

The CPU 40 executes various programs stored in the ROM 41, and stores various values in the RAM 42. The CPU 40 is electrically connected with the displaying section 43, the operating section 44, the feeder section 4, the scanner unit 9, the fixing section 11, the fan driving section 47, the internal temperature sensor 37, the temperature-humidity sensor 38, and the like. The ROM 41 stores various control programs for performing a printing operation in the laser printer 1. The RAM 42 temporarily stores values etc. calculated in the various control programs.

The displaying section 43 includes, for example, a liquid crystal display (LCD) and a lamp, and displays various setting screens and operating conditions. Further, the displaying section 43 displays a warning for warning that there is malfunction when the CPU 40 detects some malfunction in the laser printer 1. The operating section 44 includes a plurality of buttons and switches, and receives various input operations by a user, such as instructions for starting printing. When instructions for starting printing are inputted by the operating section 44 or the like, the feeder section 4 conveys the paper 3 in the paper feeding tray 6 to the image forming section 5. The temperature-humidity sensor 38 is an example of an external temperature sensor and a humidity sensor.

<Memory Area of RAM 42>

As shown in FIG. 3, the RAM 42 includes a temperature-humidity memory area AR1 and a period memory area AR2. The temperature-humidity memory area AR1 has an internal-temperature memory area AR11, an external-temperature memory area AR12, an external-humidity memory area AR13, and a dew-point-temperature memory area AR14. The period memory area AR2 has a generation-cycle memory area AR21.

The internal-temperature memory area AR11 stores the internal temperature Ta detected by the internal temperature sensor 37. The external-temperature memory area AR12 stores the external temperature Tb detected by the temperature-humidity sensor 38. The external-humidity memory area AR13 stores the external humidity Hb detected by the temperature-humidity sensor 38. The dew-point-temperature memory area AR14 stores external dew-point temperature Tr. The CPU 40 obtains the external dew-point temperature Tr from the external temperature Tb and the external humidity Hb by using a dew-point-temperature table described below.

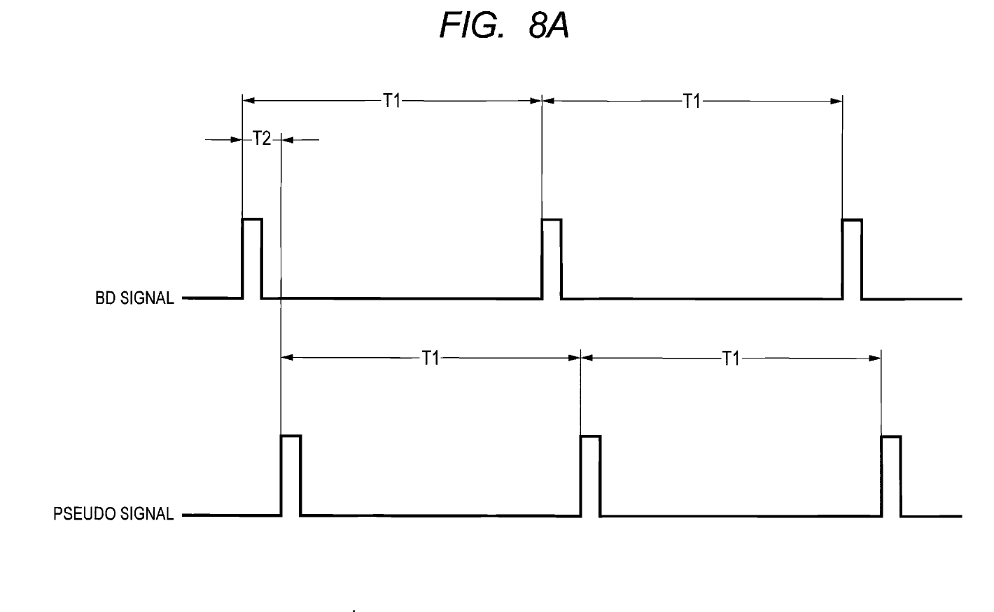

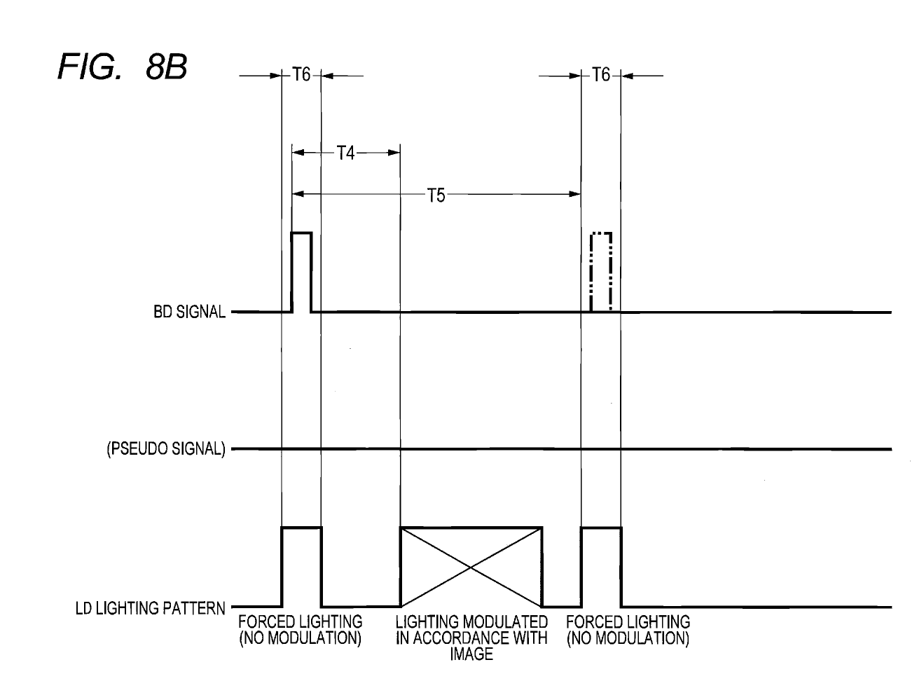

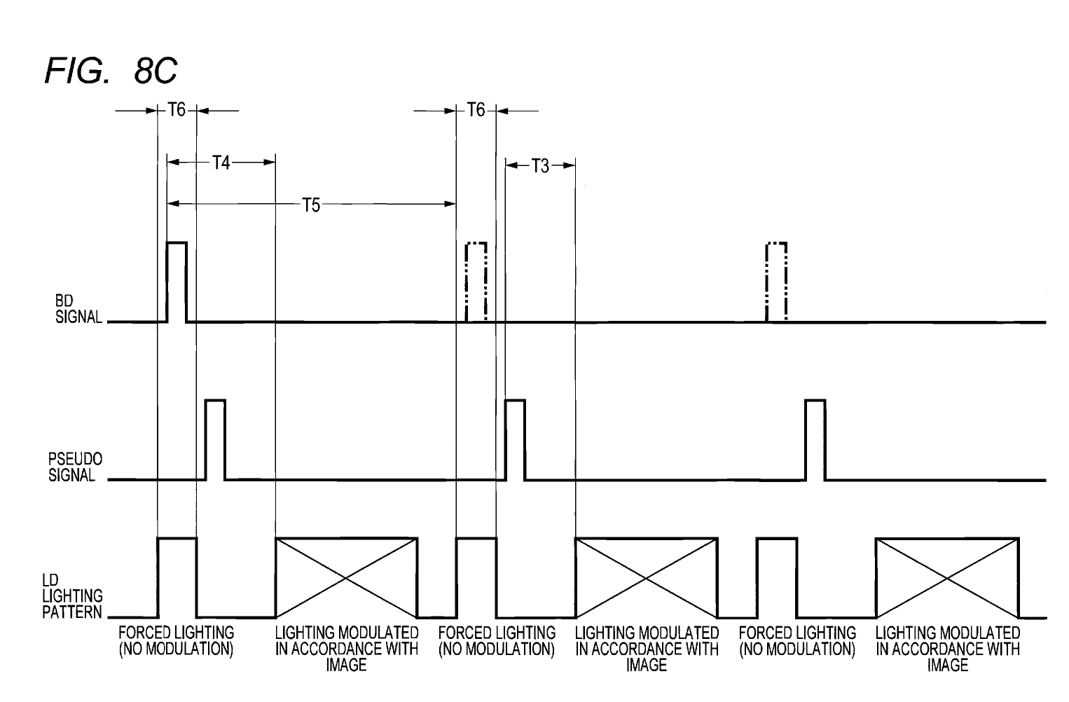

The generation-cycle memory area AR21 stores a generation cycle T1 of the BD signal (see FIG. 8A).

<Memory Area and Stored Program in ROM 41>

As shown in FIG. 3, the ROM 41 includes a period area PD1, a condensation determining area PR2, a pseudo-signal generating area PR3, an exposure control area PR4, and a dew-point-temperature area PR5.

Constant values stored in the period area PR1 will be described with reference to FIGS. 8A through 8C. The period area PR1 stores predetermined periods T2, T3, T4, T5 and an allowable generation period T6. The period T2 is a difference between the generation timing of a BD signal and the generation timing of a pseudo signal (FIG. 8A). The period T3 is a period from the generation timing of the pseudo signal to lighting start timing of the LD 12 (FIG. 8C).

The period T4 is a period from the generation timing of the BD signal to lighting start timing of the LD 12 (FIGS. 8B and 8C). The period T4 is also a period that is obtained by adding the period T2 and the period T3 (T4=T2+T3). The lighting start timing is timing at which the photosensitive member 18 is started to be scanned one line with laser light of which lighting is controlled based on image data.

The period T5 is a period from the generation timing of the previous BD signal to start timing of forced lighting of the LD 12 (FIGS. 8B and 8C). The allowable generation period T6 is a period during which forced lighting of the LD 12 is performed (FIGS. 8B and 8C). The allowable generation period T6 is a period that allows a difference between predicted generation timing of the BD signal and timing at which the BD signal is actually generated.

In a control of lighting of the LD 12, the LD 12 is lighted cyclically (referred to as “forced lighting”) to generate the BD signal. The forced lighting of the LD 12 is started after the surface of the polygon mirror 13 reflecting laser light changes due to rotation of the polygon mirror 13, and needs to be continued at least until the BD signal is generated. However, if the forced lighting is always continued until the BD signal is generated, the photosensitive member 18 is exposed to laser light for a long period when the BD signal is not generated for some reason. Hence, it is preferable that the forced lighting be performed until predicted generation timing of the BD signal, and the LD 12 be tuned off from the predicted generation timing until the lighting start timing of the LD 12.

However, the actual generation timing of the BD signal can be deviated from the predicted generation timing. Thus, as shown in FIGS. 8B and 8C, the forced lighting is performed during the allowable generation period T6 for allowing this difference. If no BD signal is generated within the allowable generation period T6, it is determined that the BD sensor 36 has malfunction.

In a condensation print mode described later, the pseudo signal is generated so that the pseudo signal rises at a time point when the period T2 elapses from the generation timing of the BD signal. As shown in FIG. 8C, the pseudo signal rises a short period after the end of the allowable generation period T6.

The cycle in which the pseudo signal is generated is the same as the generation cycle T1 of the BD signal. The generation cycle T1 is, for example, an average generation cycle of the BD signals that are generated after rotation of the polygon mirror 13 is stabilized. In the present embodiment, the BD signal is generated six times during one rotation of the polygon mirror 13. Thus, the average generation cycle is obtained by measuring a period of one rotation of the polygon mirror 13 and dividing the period by six. Or, the average generation cycle may be obtained by measuring a period in which the polygon mirror 13 rotates a plurality of times, not once, and dividing the period by an appropriate number.

The condensation determining area PR2 stores a condensation determining program. The pseudo-signal generating area PR3 stores a pseudo-signal generating program. The exposure control area PR4 stores an exposure control program.

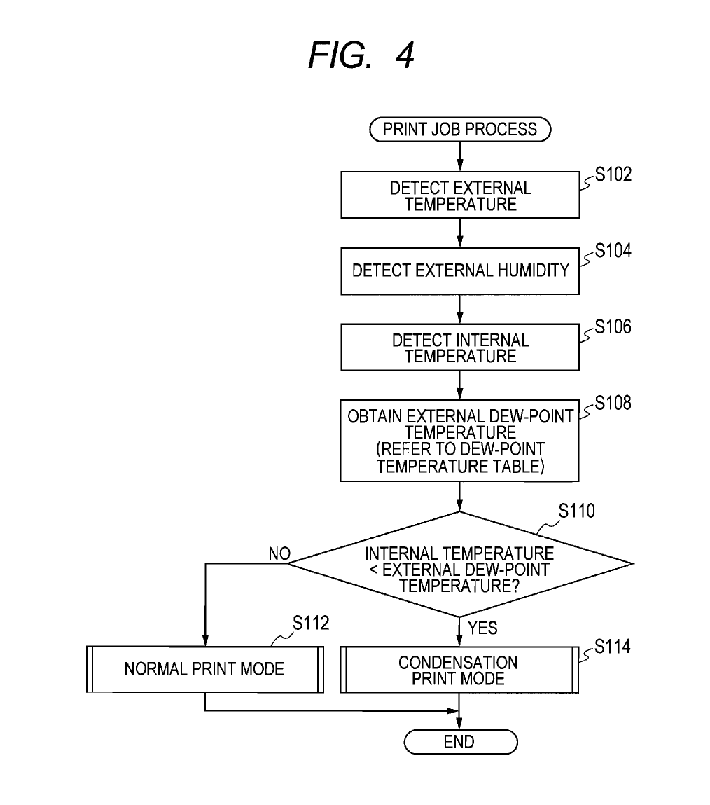

The condensation determining program is a program for determining whether possibility that condensation occurs at the BD sensor 36 is high. The condensation determining program corresponds to the process in FIG. 4.

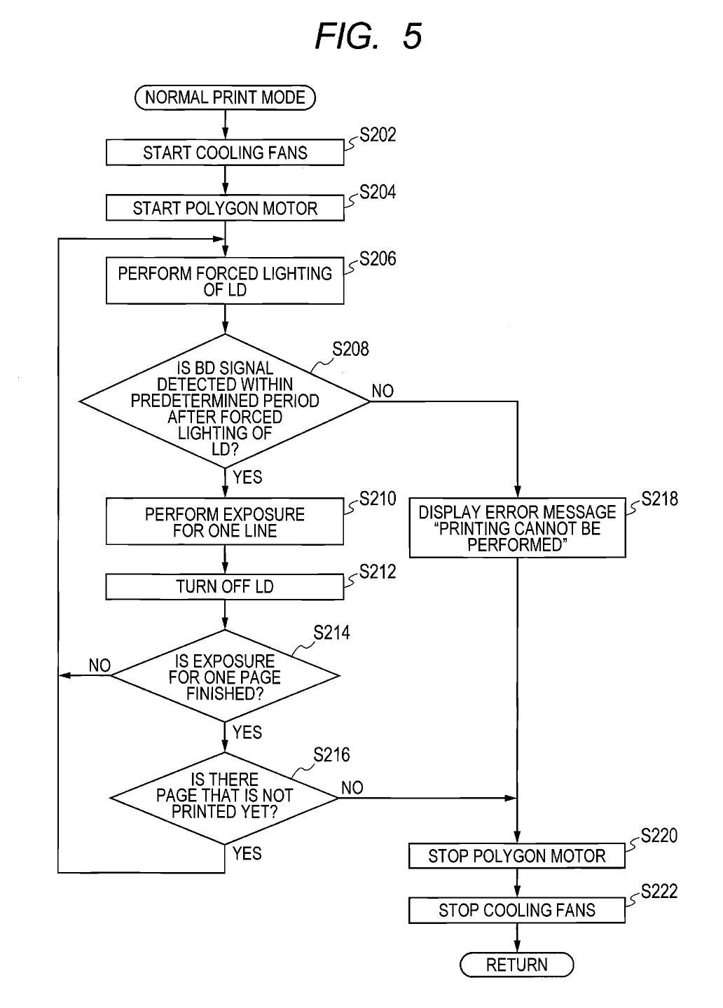

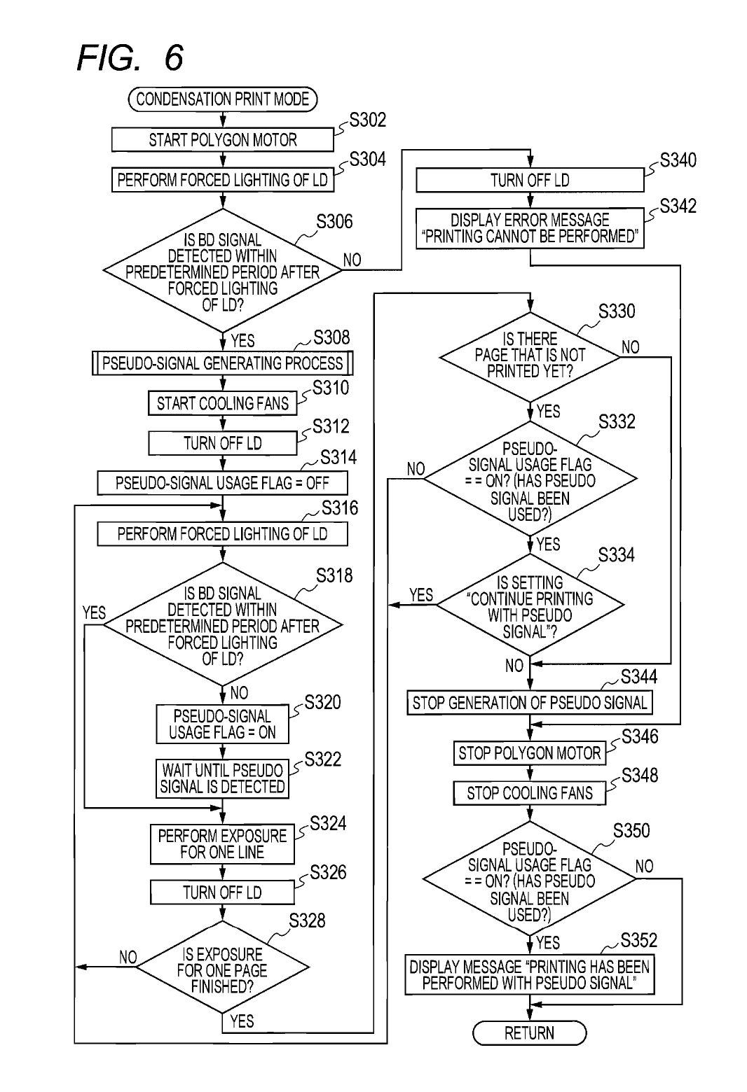

The exposure control program is a program for lighting the LD 12 by using the BD signal or the pseudo signal. The exposure control program corresponds to the processes in FIGS. 5 and 6. When the exposure control program is executed, lighting of the LD 12 is controlled based on the pseudo signal if it is determined that the possibility that condensation occurs at the BD sensor 36 is high and that the BD sensor 36 has malfunction.

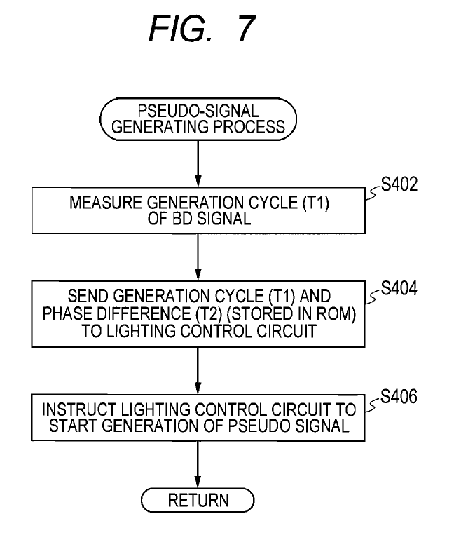

The pseudo-signal generating program is a program for generating the pseudo signal. The pseudo signal has a generation cycle having the same length as the generation cycle T1 of the BD signal, and has a phase that is delayed by the period T2 from the phase of the BD signal. The pseudo-signal generating program corresponds to the process in FIG. 7.

The dew-point-temperature area PR5 stores constant values constituting a table (dew-point-temperature table) for calculating the external dew-point temperature Tr from the external temperature Tb and the external humidity Hb. Alternatively, the external dew-point temperature Tr may be calculated by using a known equation. In this case, the dew-point-temperature area PR5 may store constant values for the equation.

A fixing control circuit 46 controls heating of the heat roller 28 by turning on/off an energization state of the halogen heater 30.

The fan driving section 47 includes a first fan driving motor 50, a second fan driving motor 51, and a motor driver 52. The first fan driving motor 50 is a motor for driving the first fan 33 to rotate. The second fan driving motor 51 is a motor for driving the second fan 34 to rotate. The motor driver 52 is connected with the first fan driving motor 50 and with the second fan driving motor 51. The motor driver 52 inputs digital signals to the first fan driving motor 50 and to the second fan driving motor 51, based on a fan driving command from the CPU 40. Rotation of the first fan driving motor 50 and the second fan driving motor 51 are controlled based on the inputted digital signals.

A polygon-mirror driving section 48 includes the polygon motor 53 and a motor driver 54. The polygon motor 53 is a motor for driving the polygon mirror 13 to rotate. The motor driver 54 is connected with the polygon motor 53. The motor driver 54 inputs digital signals to the polygon motor 53 based on a polygon-mirror driving command from the CPU 40. Rotation of the polygon motor 53 is controlled based on the inputted digital signals.

The lighting control circuit 49 is connected with the LD 12 and with the BD sensor 36. The lighting control circuit 49 controls lighting of the LD 12 based on the generation timing of the BD signal or the pseudo signal. As shown in FIGS. 8B and 8C, when the BD signal is detected normally, lighting of laser light onto the photosensitive member 18 is started at a time point when the predetermined period T4 elapses after the generation timing of the BD signal. When the BD signal is not detected in the condensation print mode, lighting of the LD 12 is controlled based on the pseudo signal. As shown in FIG. 8C, lighting of laser light onto the photosensitive member 18 is started at a time point when the predetermined period T3 elapses after the generation timing of the pseudo signal. The CPU 40 outputs, to the LD 12, a lighting signal for one line of an image, such that the LD 12 starts lighting at the lighting start timing. The lighting signal is a signal for lighting the LD 12 while being modulated in accordance with an image to be printed. The lighting control circuit 49 controls the LD 12 to light in accordance with the lighting signal. With this operation, an electrostatic latent image for one line is formed on the photosensitive member 18.

The internal temperature sensor 37 detects the internal temperature Ta (air temperature inside the main casing 2). The detected internal temperature Ta is stored in the internal-temperature memory area AR11 of the RAM 42. The temperature-humidity sensor 38 detects the external temperature Tb (air temperature outside the main casing 2) and the external humidity Hb (air humidity outside the main casing 2). The detected external temperature Tb is stored in the external-temperature memory area AR12 of the RAM 42. The detected external humidity Hb is stored in the external-humidity memory area AR13 of the RAM 42.

<Control Operation in First Embodiment>

Processes executed in the laser printer 1 according to the first embodiment will be described with reference to FIGS. 4 through 7. The CPU 40 executes the processes shown in FIG. 4 through 7 based on programs stored in each area of the ROM 41.

The following situation is assumed as an example. The power of the laser printer 1 is turned off, and the internal temperature Ta of the laser printer 1 is cooled to 5 degrees C. After that, the external temperature Tb of the laser printer 1 rises and reaches 22 degrees C., and the external humidity Hb of the laser printer 1 is 65 percent. At this time, the external dew-point temperature Tr is 15 degrees C. Thus, the internal temperature Ta of the laser printer 1 is lower than the external dew-point temperature Tr, and it is a situation where possibility that condensation occurs is high. This is, for example, a situation where the power of the laser printer 1 is turned off after work hours in an office in a relatively cold place, a heater in the office is turned on at the beginning of work hours in the morning, the power of the laser printer 1 is tuned on in a state where humidity is high due to rain, and then rotation of the first fan 33 and the second fan 34 causes outside humid, warm air to be introduced and cooled by cold air within the laser printer 1, which generates condensation within the laser printer 1. If condensation occurs within the laser printer 1, condensation may also occur at the BD sensor 36, and the BD signal cannot be generated in some cases. This is because, if condensation occurs at the BD sensor 36, water droplets adhering to the BD sensor 36 prevent the BD sensor 36 from receiving laser light. In addition, if the internal temperature Ta is low, condensation sometimes occurs due to water vapor that emanates from the paper 3 that has passed the heat roller 28. The condensation print mode in the present embodiment is for dealing with this kind of situation.

Print Job Process>

A print job process shown in FIG. 4 is stated when a print job is received after the power of the laser printer 1 is turned on. The print job is, for example, received when a user performs an input operation at the operating section 44 for instructing a start of printing. Alternatively, the print job may be received when a print command is inputted from an external personal computer (not shown) etc. connected with the laser printer 1 in a wired or wireless manner.

In S102, the CPU 40 detects the external temperature Tb with the temperature-humidity sensor 38, and stores the detected external temperature Tb in the external-temperature memory area AR12. In S104, the CPU 40 detects the external humidity Hb with the temperature-humidity sensor 38, and stores the detected external humidity Hb in the external-humidity memory area AR13. In S106, the CPU 40 detects the internal temperature Ta with the internal temperature sensor 37, and stores the detected internal temperature Ta in the internal-temperature memory area AR11.

In S108, the CPU 40 calculates the external dew-point temperature Tr by referring to the above-mentioned dew-point-temperature table as well as the external temperature Tb and the external humidity Hb, and stores the calculated external dew-point temperature Tr in the dew-point-temperature memory area AR14.

In S110, the CPU 40 compares the internal temperature Ta stored in the internal-temperature memory area AR11 with the external dew-point temperature Tr stored in the dew-point-temperature memory area AR14. If the internal temperature Ta is higher than or equal to the external dew-point temperature Tr (S110: No), then the CPU 40 proceeds to S112 and executes a normal print mode. This case indicates that it is determined that possibility that condensation occurs at the BD sensor 36 is not high. On the other hand, if the internal temperature Ta is lower than the external dew-point temperature Tr (S110: Yes), then the CPU 40 proceeds to S114 and executes a condensation print mode. This case indicates that it is determined that possibility that condensation occurs at the BD sensor 36 is high.

In the example described earlier, the internal temperature Ta (5 degrees C.) is lower than the external dew-point temperature Tr (15 degrees C.). Hence, the CPU 40 determines that the possibility that condensation occurs at the BD sensor 36 is high (S110: Yes), and thus proceeds to S114.

<Normal Print Mode>

Processes in the normal print mode shown in FIG. 5 is described. For simplicity, processes relating mainly to exposure controls are described in the flowchart of FIG. 5. That is, processes relating to controls for feeding paper and controls for fixing toner on paper, and the like are omitted.

In S202, the CPU 40 controls the fan driving section 47 to start rotations of the first fan 33 and the second fan 34. With this operation, air inside the main casing 2 and external air can be exchanged (mixed).

In S204, the CPU 40 controls the motor driver 54 to start rotation of the polygon motor 53. The motor driver 54 performs a constant-speed control of the polygon motor 53, such that the polygon motor 53 rotates stably at a predetermined speed. If the polygon motor 53 is already in a state of stable rotation, that state is maintained.

In S206, as shown in FIG. 8B, the CPU 40 controls the lighting control circuit 49 to light the LD 12 without modulation (forced lighting) during the allowable generation period T6.

In S208, the CPU 40 determines whether the BD signal is detected within the allowable generation period T6 from start timing of forced lighting of the LD 12. The CPU 40 proceeds to S210 if the BD signal is detected within the allowable generation period T6 (S208: Yes), and proceeds to S218 if the BD signal is not detected within the allowable generation period T6 (S208: No). For example, in the first one of two times of forced lighting shown in FIG. 8B, the BD signal is detected within the allowable generation period T6, and thus the process goes to S210.

In S210, exposure for one line of an image is performed. As shown in FIG. 8B, the lighting control circuit 49 controls the LD 12 to light in accordance with a lighting signal for image formation (a lighting signal modulated in accordance with an image; this kind of lighting signal is denoted by crossed lines (“X”-shaped lines) in FIGS. 8B and 8C), starting at a time point when the period T4 elapses after generation of the BD signal. Then, in S212, the LD 12 is turned off.

In S214, the CPU 40 determines whether exposure for one page is finished. This can be done, for example, by counting the number of times the process in S210 is executed and by determining whether the number of times reaches the number of lines required for printing one page. If it is determined that exposure for one page is not finished (S214: No), then the CPU 40 returns to S206 and repeats the above-described processes. If it is determined that exposure for one page is finished (S214: Yes), then the CPU 40 proceeds to S216.

In S216, the CPU 40 determines whether there is a page that is not printed yet in the current print job. If it is determined that there is a page that is not printed yet (S216: Yes), then the CPU 40 returns to S206 and continues printing in the current print job. If it is determined that all pages are printed in the current print job (S216: No), then the CPU 40 proceeds to S220.

In S220, the CPU 40 controls the motor driver 54 to stop rotation of the polygon motor 53. Then, in S222, the CPU 40 controls the fan driving section 47 to stop rotations of the first fan 33 and the second fan 34, and ends this printing operation.

On the other hand, if the BD signal is not detected within the allowable generation period T6 in S208 (S208: No), then in S218 the CPU 40 controls the displaying section 43 to display an error message that printing cannot be performed. For example, in the second one of two times of forced lighting shown in FIG. 8B, the BD signal is not detected within the allowable generation period T6, and thus the process goes to S218 for displaying the error message. Then, rotations of the polygon motor 53 and the fans 33 and 34 are stopped (S220, S222) to stop printing. In this way, in the normal print mode shown in FIG. 5, printing is cancelled if detection of the BD signal is broken.

<Condensation Print Mode>

Next, processes in the condensation print mode shown in FIG. 6 are described. Like FIG. 5, processes relating mainly to exposure controls are described in the flowchart of FIG. 6, for simplicity.

First, in S302, the CPU 40 controls the motor driver 54 to start rotation of the polygon motor 53 and the polygon mirror 13. The motor driver 54 performs a constant-speed control of the polygon motor 53, such that the polygon motor 53 and the polygon mirror 13 rotate stably at a predetermined speed. At this time, because it is unknown in which direction the polygon mirror 13 is oriented, it is also unknown at which position in a scanning range the laser light reflected by the polygon mirror 13 is irradiated.

Hence, in S304, the CPU 40 controls the lighting control circuit 49 to light the LD 12 without modulation (forced lighting), and waits for laser light emitted by the LD 12 and reflected by the rotating polygon mirror 13 to be received by the BD sensor 36 so that the BD signal is generated. That is, the CPU 40 waits for laser light to come to a position of the BD sensor 36. Here, a time point when the BD signal is generated is a time point when the polygon mirror 13 is oriented so that laser light is received by the BD sensor 36. After that, each time the BD signal is generated, the CPU 40 measures a period that elapses from the time point when the BD signal is generated. Because the polygon mirror 13 is rotated at a constant speed as described above, an orientation of the polygon mirror 13 can be obtained by calculation.

In S306, the CPU 40 determines whether the BD signal is detected within the allowable generation period T6 from start timing of forced lighting of the LD 12. The CPU 40 proceeds to S308 if the BD signal is detected within the allowable generation period T6 (S306: Yes), and proceeds to S340 if the BD signal is not detected within the allowable generation period T6 (S306: No). For example, in the first one of three times of forced lighting shown in FIG. 8C, the BD signal is detected within the allowable generation period T6, and thus the process goes to S308.

In S308, the CPU 40 executes a pseudo-signal generating process shown in FIG. 7 for generating a pseudo signal. As shown in FIG. 8A, the pseudo signal has a generation cycle having the same length as the generation cycle T1 of the BD signal, and its generation timing (phase) is delayed by the period T2 from the generation timing of the BD signal.

When the pseudo-signal generating process shown in FIG. 7 is called, in S402, the CPU 40 measures the generation cycle T1 of the BD signal and stores the measured generation cycle T1 in the generation-cycle memory area AR21 of the RAM 42 in a state where the polygon motor 53 is rotated stably. Here, as described above, the CPU 40 measures a period for at least one rotation of the polygon motor 53, and calculates the generation cycle T1 of the BD signal.

In S404, the CPU 40 sends both the generation cycle T1 and the period T2 (phase difference) stored in the period area PR1 to the lighting control circuit 49.

In S406, the CPU 40 instructs the lighting control circuit 49 to generate a pseudo signal. Upon receipt of this instruction, the lighting control circuit 49 generates the pseudo signal that has a generation cycle having the same length as the generation cycle T1 of the BD signal, and that has a phase that is delayed by the period T2 from the phase of the BD signal. Once generation of the pseudo signal is started, the lighting control circuit 49 continues generating the pseudo signal until the CPU 40 instructs the lighting control circuit 49 to stop generation of the pseudo signal (S344). This allows switching from the BD signal to the pseudo signal when the BD signal is not generated in S318 described later. Note that the LD 12 is controlled to continue lighting without being modulated until the LD 12 is turned off in S312.

Subsequent to S406, the pseudo-signal generating process shown in FIG. 7 ends and the process returns to the flowchart in FIG. 6. In S310, the CPU 40 controls the fan driving section 47 to start rotations of the first fan 33 and the second fan 34. In S312, the LD 12 is turned off, and forced lighting ends.

In S314, the CPU 40 resets a pseudo-signal usage flag to “OFF”. The pseudo-signal usage flag is a flag for indicating whether a pseudo signal has been used. In this step, the flag is reset in order to prepare for the following processes.

In S316, the lighting control circuit 49 turns on the LD 12 for the allowable generation period T6 (forced lighting). That is, the LD 12 emits laser light without modulation. This forced lighting is started when the predetermined period T5 elapses after the previous generation timing of the BD signal (FIG. 8C). Thus, forced lighting of the LD 12 can be performed in synchronization with rotation of the polygon mirror 13.

In S318, the CPU 40 determines whether the BD signal is detected within the allowable generation period T6 after start timing of forced lighting of the LD 12. The CPU 40 proceeds to S324 if the BD signal is detected within the allowable generation period T6 (S318: Yes), and proceeds to S320 if the BD signal is not detected within the allowable generation period T6 (S318: No).

For example, in the first one of three times of forced lighting shown in FIG. 8C, the BD signal is detected within the allowable generation period T6 (S318: Yes), and thus the process goes to S324. That is, as shown in FIG. 8C, at a time point when the period T4 elapses after the BD signal is generated, the lighting control circuit 49 controls the LD 12 to start lighting in accordance with a lighting signal (lighting signal modulated in accordance with an image), thereby performing exposure for one line.

In contrast, in the second one of three times of forced lighting shown in FIG. 8C, the BD signal is not detected within the allowable generation period T6 (S318: No), and thus the process goes to S320. In S320, the CPU 40 sets the pseudo-signal usage flag to “ON”, and waits until the pseudo signal is detected (S322). As shown in FIG. 8C, at a time point when the period T3 elapses after the pseudo signal is generated, the lighting control circuit 49 controls the LD 12 to start lighting in accordance with a lighting signal (lighting signal modulated in accordance with an image), thereby performing exposure for one line (S324).

When exposure for one line is finished, in S326, the LD 12 is turned off.

In S328, the CPU 40 determines whether exposure for one page is finished. This can be done, for example, by counting the number of times the process in S324 is executed and by determining whether the number of times reaches the number of lines required for printing one page. If it is determined that exposure for one page is not finished (S328: No), then the CPU 40 returns to S316 and repeats the above-described processes. If it is determined that exposure for one page is finished (S328: Yes), then the CPU 40 proceeds to S330.

As described above, in S316, forced lighting of the LD 12 is started when the predetermined period T5 elapses after the previous generation timing of the BD signal. However, if the BD signal discontinues in the middle of printing, the generation timing of the BD signal cannot be used anymore. Hence, forced lighting is started when the generation cycle T1 elapses after the start timing of the previous forced lighting.

In S330, the CPU 40 determines whether there is a page that is not printed yet in the current print job. If it is determined that there is a page that is not printed yet (S330: Yes), then the CPU 40 proceeds to S332. If it is determined that all pages are printed in the current print job (S330: No), then the CPU 40 proceeds to S344.

In S332, the CPU 40 determines whether the pseudo-signal usage flag is “ON”, that is, whether the pseudo signal has been used. If the pseudo-signal usage flag is “ON” (S332: Yes), then the CPU 40 proceeds to S334. If the pseudo-signal usage flag is “OFF” (S332: No), then the CPU 40 returns to S316 and performs printing for the subsequent page.

In S334, the CPU 40 determines whether setting of the laser printer 1 is “continue printing with pseudo signal”. The fact that it is determined in S332 that the pseudo-signal usage flag is “ON” indicates that printing has been performed by switching from the BD signal to the pseudo signal because the possibility that condensation occurs at the BD sensor 36 is high. If printing is performed using the pseudo signal, it is possible that the pseudo signal and the lighting start timing cannot be synchronized and thus printing quality cannot be maintained. Hence, in the present embodiment, a user can select preliminarily, by using the operating section 44, whether to continue the subsequent print job with the pseudo signal or to discontinue printing, when printing has been performed by switching from the BD signal to the pseudo signal. Alternatively, the laser printer 1 may instruct the user, in S334, to select whether to continue the subsequent print job with the pseudo signal or to discontinue printing, by displaying a message on the displaying section 43. Here, the subsequent print job means a print job that is received by the time the previous printing is finished, or a print job that is received after the previous printing is finished.

In S334, if the setting of the laser printer 1 is “continue printing with pseudo signal” (S334: Yes), then the CPU 40 returns to S316 and continues printing. If the setting of the laser printer 1 is not “continue printing with pseudo signal” (S334: No), then the CPU 40 proceeds to S344.

In S344, the CPU 40 sends, to the lighting control circuit 49, a command for stopping generation of the pseudo signal, so that generation of the pseudo signal is stopped. In S346, the CPU 40 controls the motor driver 54 to stop rotation of the polygon motor 53. Then, in S348, the CPU 40 controls the fan driving section 47 to stop rotations of the first fan 33 and the second fan 34.

In S350, the CPU 40 determines whether the pseudo-signal usage flag is “ON”, that is, whether the pseudo signal has been used. If the pseudo-signal usage flag is “ON” (S350: Yes), then the CPU 40 proceeds to S352 and displays, on the displaying section 43, a message that “printing has been performed with pseudo signal”. If the pseudo-signal usage flag is “OFF” (S350: No), then the CPU 40 skips the process in S352 and finishes the processes in FIG. 6.

On the other hand, in S306, if the BD signal is not detected within the allowable generation period T6 (S306: No), then in S340 the LD 12 is turned off because it is assumed that there is some malfunction. In S342, the CPU 40 displays, on the displaying section 43, an error message that “printing cannot be performed”. In S346, the CPU 40 controls the motor driver 54 to stop the polygon motor 53 (that is, discontinue electrical supply to the polygon motor 53). In S348, the CPU 40 controls the fan driving section 47 to stop rotations of the fans 33 and 34. Then, because the pseudo-signal usage flag is “OFF” (S350: No), the CPU 40 skips the process in S352 and ends the processes in FIG. 6. In this case, the processes in FIG. 6 end by an error, without performing printing.

### ADVANTAGEOUS EFFECTS

In the laser printer 1 in the above-described embodiment, the lighting start timing of the LD 12 is controlled by using the pseudo signal instead of the BD signal, if it is determined that possibility that condensation occurs at the BD sensor 36 is high and that the BD sensor 36 has malfunction. The pseudo signal has a generation cycle having the same length as the generation cycle of the BD signal. Hence, an image can be formed by using the pseudo signal even if the BD signal is not generated due to condensation.

Further, there is a known method in which an intermittent print mode is executed if it is determined that condensation occurs within a laser printer. In the intermittent print mode, when printing is performed on a plurality of pages, a time interval between pages is set to a longer value than in a normal continuous print mode. This can reduce an amount of water vapor that emanates from paper passing through a fixing section, thereby suppressing condensation. In the intermittent print mode, however, a longer period is required for printing the plurality of pages. In contrast, according to the laser printer 1 in the above-described embodiment, by using the pseudo signal, an image can be formed without lowering speed even if the BD signal is not generated due to condensation.

According to the laser printer 1 of the above-described embodiment, the pseudo signal is not generated if it is determined that the possibility that condensation occurs at the BD sensor 36 is not high (the normal print mode), and the pseudo signal is generated if it is determined that the possibility that condensation occurs at the BD sensor 36 is high (the condensation print mode). This is efficient because the pseudo signal is generated only in necessary situations.

According to the laser printer 1 of the above-described embodiment, the condensation print mode is executed if it is determined that the internal temperature Ta detected by the internal temperature sensor 37 is lower than the external dew-point temperature Tr. If the internal temperature Ta is lower than the external dew-point temperature Tr, the possibility that condensation occurs at the BD sensor 36 is very high. Accordingly, the condensation print mode can be executed more reliably if the possibility that condensation occurs at the BD sensor 36 is high.

According to the laser printer 1 of the above-described embodiment, in the condensation print mode, the fans 33 and 34 are driven to rotate after the pseudo signal is generated. If it is determined that the possibility that condensation occurs at the BD sensor 36 is high, rotation of the fans causes air outside the main casing 2 and air inside the main casing 2 to be exchanged, which further increases the possibility that condensation occurs at the BD sensor 36. In the above-described embodiment, the pseudo signal is generated before the fans 33 and 34 are rotated and condensation occurs at the BD sensor 36. Thus, the pseudo signal can be generated more reliably in a normal state where there is no condensation.

According to the laser printer 1 of the above-described embodiment, lighting control of the LD 12 is performed based on the pseudo signal if the user chooses to perform the subsequent print job when the current print job is finished, and generation of the pseudo signal is discontinued if the user chooses not to perform the subsequent print job. Accordingly, the user can choose whether the subsequent print job is to be performed based on the pseudo signal while looking at the printing results of the current print job, when the current print job is finished. Hence, the user can obtain the printing results with the pseudo signal, for example, if it is necessary to perform printing immediately even if printing quality may be degraded to some extent. On the other hand, the user can stop printing, for example, if it is not necessary to perform printing immediately.

According to the laser printer 1 of the above-described embodiment, the pseudo signal is generated when the period T2 elapses after the generation timing of the BD signal, in a state where the BD signal is generated in a constant generation cycle. Accordingly, if the BD signal is not generated within the allowable generation period T6, the lighting timing of the LD 12 can be controlled based on the generation timing of the pseudo signal.

### Second Embodiment

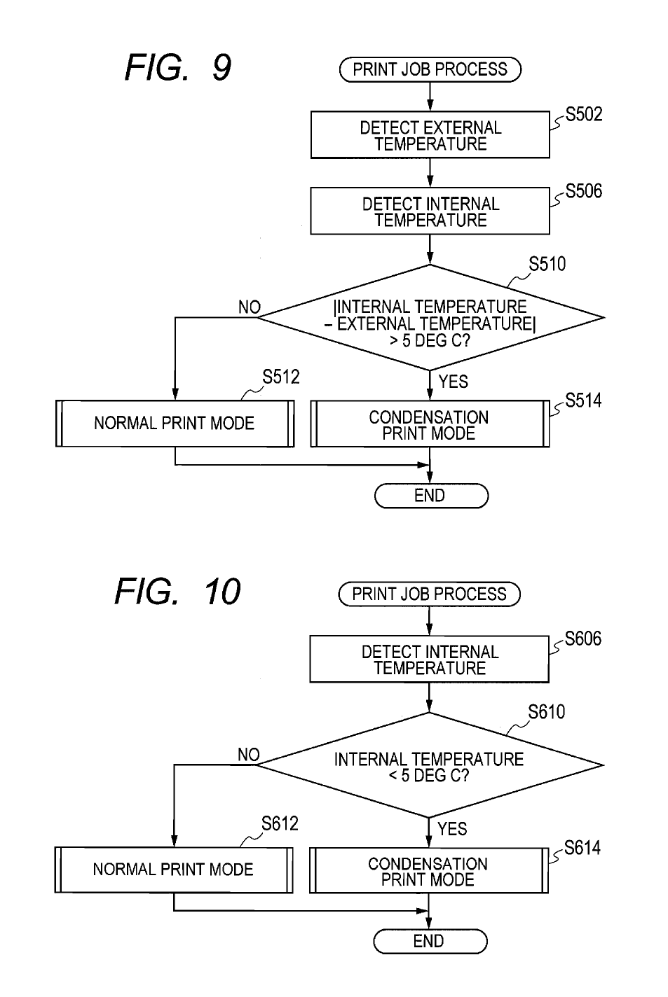

A print job process executed by a laser printer according to a second embodiment will be described with reference to FIG. 9, wherein like parts and components are designated by the same reference numerals to avoid duplicating description. The laser printer according to the second embodiment includes an external temperature sensor (not shown) instead of the temperature-humidity sensor 38 in the first embodiment. That is, a humidity sensor is omitted. With this configuration, if temperature difference is large between inside the printer and outside the printer, a printing operation is performed by assuming that the possibility that condensation occurs at the BD sensor 36 is high.

Like the first embodiment, upon receiving a print job, a print job process is started in accordance with the flowchart of FIG. 9.

In S502, the CPU 40 controls the external temperature sensor (not shown) to detect the external temperature Tb and stores the detected external temperature Tb in the external-temperature memory area AR12. In S506, the CPU 40 controls the internal temperature sensor 37 to detect the internal temperature Ta and stores the detected internal temperature Ta in the internal-temperature memory area AR11.

In S510, the CPU 40 obtains an absolute value of difference between the internal temperature Ta stored in the internal-temperature memory area AR11 and the external temperature Tb stored in the external-temperature memory area AR12, and determines whether the absolute value is greater than 5 degrees C. If the absolute value is smaller than or equal to 5 degrees C. (S510: No), then the CPU 40 proceeds to S512 and executes the normal print mode. This indicates that it is determined that the possibility that condensation occurs at the BD sensor 36 is not high. If the absolute value is larger than 5 degrees C. (S510: Yes), then the CPU 40 proceeds to S514 and executes the condensation print mode. This indicates that it is determined that the possibility that condensation occurs at the BD sensor 36 is high. The processes in the normal print mode and in the condensation print mode are the same as those in the first embodiment.

Here, the reason to obtain the absolute value of the difference between the internal temperature Ta and the external temperature Tb is that both cases are possible in which the external temperature Tb is higher than the internal temperature Ta and in which the internal temperature Ta is higher than the external temperature Tb, and that condensation is likely to occur when temperature difference is large in the both cases.

According to the second embodiment, the configuration of the laser printer can be simplified because a humidity sensor can be omitted. Further, because a dew-point temperature is not used, a storage area for the dew-point-temperature table is not necessary, and a process of calculating the dew-point temperature is not necessary, either.

### Third Embodiment

A print job process executed by a laser printer according to a third embodiment will be described with reference to FIG. 10, wherein like parts and components are designated by the same reference numerals to avoid duplicating description. The laser printer according to the third embodiment does not include the temperature-humidity sensor 38 in the first embodiment. That is, an external temperature sensor and a humidity sensor are omitted. With this configuration, if the internal temperature is lower than a predetermined temperature, a printing operation is performed by assuming that the possibility that condensation occurs at the BD sensor 36 is high.

Like the first and second embodiments, upon receiving a print job, a print job process is started in accordance with the flowchart of FIG. 10.

In S606, the CPU 40 controls the internal temperature sensor 37 to detect the internal temperature Ta and stores the detected internal temperature Ta in the internal-temperature memory area AR11.

In S610, the CPU 40 determines whether the internal temperature Ta stored in the internal-temperature memory area AR11 is lower than 5 degrees C. If the internal temperature Ta is higher than or equal to 5 degrees C. (S610: No), then the CPU 40 proceeds to S612 and executes the normal print mode. This indicates that it is determined that the possibility that condensation occurs at the BD sensor 36 is not high. If the internal temperature Ta is lower than 5 degrees C. (S610: Yes), then the CPU 40 proceeds to S614 and executes the condensation print mode. This indicates that it is determined that the possibility that condensation occurs at the BD sensor 36 is high. The processes in the normal print mode and in the condensation print mode are the same as those in the first embodiment.

According to the third embodiment, the configuration of the laser printer can be further simplified because an external temperature sensor and a humidity sensor can be omitted. In addition, the processes can be even more simplified compared with the second embodiment, because it is not necessary to calculate the absolute value of the difference between the internal temperature Ta and the external temperature Tb.

### Modifications

While the invention has been described in detail with reference to the above aspects thereof, it would be apparent to those skilled in the art that various changes and modifications may be made therein without departing from the scope of the claims. Examples are described below.

In the above-described embodiment, the image forming apparatus of the invention is applied to a laser printer. However, the invention may be applied to other image forming apparatuses, such as a copier, a multifunction device, and the like.

In the above-described embodiment, the BD sensor 36 is disposed at a position through which laser light passes before the laser light scans the photosensitive member 18. However, the BD sensor 36 may be disposed at a position through which laser light passes after the laser light scans the photosensitive member 18.

In the above-described embodiment, the polygon mirror 13 is used to deflect laser light. However, a galvanometer mirror may be used.

In the above-described embodiments, the laser printer 1 executes a process of determining whether the possibility that condensation occurs is high (the print job processes in FIGS. 4, 9, and 10) when a print job is received. However, this process may be executed at different timing, for example, when the power of the laser printer 1 is turned on, when the laser printer 1 returns from a sleep mode, when a long period (for example, three hours) elapses after the previous print job is processed and before the current print job is received, and the like. In this case, the laser printer 1 may store determination results obtained in the above-mentioned process (the process of determining whether the possibility that condensation occurs is high) in the RAM or the like and, upon receiving a print job, may select and execute either the normal print mode or the condensation print mode based on the determination results.

What is claimed is:

1. An image forming apparatus comprising:
a main casing;
a photosensitive member;
a light emitting element configured to emit laser light;
a light deflector configured to deflect the laser light and to scan the photosensitive member with the laser light in a main scanning direction to form an electrostatic latent image;
a light receiving sensor configured to receive the laser light scanned by the light deflector and to generate a detection signal;
a pseudo-signal generating section configured to generate a pseudo signal having a cycle that has the same length as a generation cycle of the detection signal;
a lighting control section configured to control lighting start timing at which the light emitting element starts lighting based either on the detection signal or on the pseudo signal;
a condensation determining section configured to determine whether possibility that condensation occurs at the light receiving sensor is high based on a predetermined criterion; and
a malfunction determining section configured to determine that the light receiving sensor has malfunction if the light receiving sensor fails to generate the detection signal within a predetermined period,
wherein the lighting control section is configured to control the lighting start timing based on the pseudo signal, if the condensation determining section determines that the possibility is high and if the malfunction determining section determines that the light receiving sensor has malfunction.

2. The image forming apparatus according to claim 1, wherein the pseudo-signal generating section is configured to generate the pseudo signal if the condensation determining section determines that the possibility is high, and not to generate the pseudo signal if the condensation determining section determines that the possibility is not high.

3. The image forming apparatus according to claim 1, further comprising:
an internal temperature sensor configured to detect an internal temperature inside the main casing;
an external temperature sensor configured to detect an external temperature outside the main casing;
a humidity sensor configured to detect a humidity outside the main casing;
a dew-point-temperature obtaining section configured to obtain a dew-point temperature based on the external temperature detected by the external temperature sensor and on the humidity detected by the humidity sensor; and
a temperature determining section configured to determine whether the internal temperature detected by the internal temperature sensor is lower than the dew-point temperature obtained by the dew-point-temperature obtaining section,
wherein the condensation determining section is configured to determine that the possibility is high if the temperature determining section determines that the internal temperature is lower than the dew-point temperature.

4. The image forming apparatus according to claim 1, further comprising an internal temperature sensor configured to detect an internal temperature inside the main casing,
wherein the condensation determining section is configured to determine that the possibility is high if the internal temperature is lower than a predetermined temperature.

5. The image forming apparatus according to claim 1, further comprising:
a fan configured to exchange air between outside the main casing and inside the main casing;
a fan driving section configured to drive the fan; and
a driving control section configured to control the fan driving section to drive the fan after the pseudo signal is generated.

6. The image forming apparatus according to claim 1, further comprising:
a light-deflector driving control section configured to control driving of the light deflector;
a print-job receiving section configured to receive a print job;
a print-job executing section configured to execute the print job received by the print-job receiving section; and
a print-job determining section configured to determine whether to execute a next print job after a current print job is finished,
wherein the lighting control section is configured to control the lighting start timing based on the pseudo signal if the print-job determining section determines that the next print job is to be executed, and to cancel generation of the pseudo signal if the print-job determining section determines that the next print job is not to be executed.

7. The image forming apparatus according to claim 1, wherein the lighting control section is configured to control the light emitting element to perform forced lighting for an allowable generation period in a cyclic manner; and
wherein the lighting control section is configured to wait generation of the detection signal for the allowable generation period and, if the detection signal is not generated within the allowable generation period, control the lighting start timing based on the pseudo signal.

8. An image forming apparatus comprising:
a main casing;
a photosensitive member;
a light emitting element configured to emit laser light;
a light deflector configured to deflect the laser light emitted from the light emitting element and to scan the photosensitive member with the laser light in a predetermined direction;
a light receiving sensor configured to receive the laser light deflected by the light deflector and to generate a detection signal;
a pseudo-signal generating section configured to generate a pseudo signal;
a lighting control section configured to control lighting start timing of the light emitting element based either on the detection signal or on the pseudo signal;
a condensation determining section configured to determine whether possibility that condensation occurs at the light receiving sensor is high based on a predetermined criterion; and
a print controlling section configured to perform printing in a first print mode if the condensation determining section determines that the possibility is not high, and to perform printing in a second print mode if the condensation determining section determines that the possibility is high,
wherein, in the second print mode, the lighting control section is configured to control the lighting start timing based on the detection signal if the light receiving sensor generates the detection signal within a predetermined period after forced lighting of the light emitting element, and to control the lighting start timing based on the pseudo signal if the light receiving sensor fails to generate the detection signal within the predetermined period.

9. The image forming apparatus according to claim 8, further comprising:
an internal temperature sensor configured to detect an internal temperature inside the main casing;
an external temperature sensor configured to detect an external temperature outside the main casing;
a humidity sensor configured to detect a humidity outside the main casing; and
a dew-point-temperature obtaining section configured to obtain a dew-point temperature based on the external temperature detected by the external temperature sensor and on the humidity detected by the humidity sensor,
wherein the condensation determining section is configured to determine that the possibility is high if the internal temperature is lower than the dew-point temperature.

10. The image forming apparatus according to claim 8, further comprising:
an internal temperature sensor configured to detect an internal temperature inside the main casing; and
an external temperature sensor configured to detect an external temperature outside the main casing,
wherein the condensation determining section is configured to determine that the possibility is high if a difference between the internal temperature and the external temperature is larger than a predetermined value.

11. The image forming apparatus according to claim 8, further comprising:
an internal temperature sensor configured to detect an internal temperature inside the main casing,
wherein the condensation determining section is configured to determine that the possibility is high if the internal temperature is lower than a predetermined temperature.

12. The image forming apparatus according to claim 8, wherein the pseudo signal has a cycle having the same length as a cycle of the detection signal; and
wherein generation timing of the pseudo signal is delayed from generation timing of the detection signal by a predetermined phase difference.

13. The image forming apparatus according to claim 12, wherein the lighting control section is configured to start lighting when a first predetermined period elapses after the generation timing of the detection signal if the lighting start timing is controlled based on the detection signal, and to start lighting when a second predetermined period elapses after the generation timing of the pseudo signal if the lighting start timing is controlled based on the pseudo signal; and
wherein the first predetermined period is obtained by adding the predetermined phase difference and the second predetermined period.

14. The image forming apparatus according to claim 8, further comprising a pseudo-signal continuation determining section that is configured to determine whether to continue printing of a subsequent page based on the pseudo signal.

15. An image forming apparatus comprising:
a main casing;
a photosensitive member;
a light emitting element configured to emit laser light;
a light deflector configured to deflect the laser light and to scan the photosensitive member with the laser light in a main scanning direction to form an electrostatic latent image;
a light receiving sensor configured to receive the laser light scanned by the light deflector and to generate a detection signal;
means for generating a pseudo signal having a cycle that has the same length as a generation cycle of the detection signal;
means for controlling lighting start timing at which the light emitting element starts lighting based either on the detection signal or on the pseudo signal;
means for determining whether possibility that condensation occurs at the light receiving sensor is high based on a predetermined criterion; and
means for determining that the light receiving sensor has malfunction if the light receiving sensor fails to generate the detection signal within a predetermined period,
wherein the lighting start timing is controlled based on the pseudo signal, if it is determined that the possibility is high and that the light receiving sensor has malfunction.
